(19) United States
(12) Patent Application Publication
(10) Pub. No.: US 2020/0081124 A1
(43) Pub. Date: Mar. 12, 2020

(54) METHOD AND DEVICE FOR FILTERING OUT NON-GROUND POINTS FROM POINT CLOUD, AND STORAGE MEDIUM

(71) Applicant: Baidu Online Network Technology (Beijing) Co., Ltd, Beijing (CN)

(72) Inventor: Tingmin Shi, Beijing (CN)

(21) Appl. No.: 16/454,151

(22) Filed: Jun. 27, 2019

(30) Foreign Application Priority Data
Sep. 7, 2018 (CN) 201811045711.5

(51) Int. Cl. G01S 17/42; G01S 7/48

(52) U.S. Cl. CPC G01S 17/42; G01S 7/4808

(57) ABSTRACT

Methods and devices for filtering out non-ground points from a point cloud. A method includes acquiring a point cloud by scanning ground with light detection and ranging (LiDAR); calculating radial distances of adjacent points in the point cloud; determining key points based on a variation of the radial distances of adjacent points; and filtering out non-ground points from the point cloud based on the key points. Key points are determined based on the radial distances of adjacent points in the point cloud, and then the non-ground points are filtered out.

### CROSS-REFERENCE TO RELATED APPLICATION

This application claims priority to Chinese Patent Application No. 201811045711.5, filed on Sep. 7, 2018, which is hereby incorporated by reference in its entirety.

### TECHNICAL FIELD

The present disclosure relates to the field of information technology, and in particular to a method and device for filtering out non-ground points from a point cloud, and a computer readable storage medium.

### BACKGROUND

A point data set of the outer surface of a to-be-detected object obtained by a measuring instrument (such as Light Detection and Ranging, LiDAR) is also referred to as a point cloud. When a laser beam is irradiated onto the surface of the object, the laser reflected from the object may carry information on orientation, distance and the like. If the laser beam scans in accordance with a certain trajectory, information on the reflected laser points is recorded while scanning. Since the scanning is extremely fine, a large quantity of laser points can be obtained, thereby forming a laser point cloud.

Ground points need to be removed from the point cloud before an obstacle is detected using the point cloud. Typically, a ground plane fitting is performed, and then a distance between each point and a fitted plane is calculated using the fitted plane so as to filter out the ground points. Inaccuracies in determining which points are the ground points during the ground plane fitting can occur. In such a case, wrong points may be selected for the fitting, and the result of the ground plane fitting is inaccurate. Particularly, if a posture of a vehicle body or the ground varies greatly, a wrong fitted plane may be obtained, thereby causing errors in the filtering.

### SUMMARY

A method and device for filtering out non-ground points from a point cloud and a computer readable storage medium are provided, to at least solve one or more technical problems in existing technologies.

In a first aspect, according to an embodiment, a method for filtering out non-ground points from a point cloud is provided, the method includes: acquiring a point cloud by scanning ground with light detection and ranging (LiDAR); calculating radial distances of adjacent points in the point cloud; determining key points based on a variation of the radial distances of adjacent points; and filtering out non-ground points from the point cloud based on the key points.

In embodiments, the adjacent points include points obtained by scanning the ground using adjacent laser heads of the LiDAR or points obtained by scanning the ground using one laser head of the LiDAR at adjacent scanning angles. The radial distance is a distance from a projection position of a point of the point cloud to a coordinate origin in the top view plane. The coordinate origin in the top view plane is a projection of a laser origin in the top view plane.

In embodiments, the method can include determining key points based on a variation of the radial distances of adjacent points including: setting a threshold for the variation of the radial distances; and determining at least one of the adjacent points as a key point, in a case that the variation of the radial distances of adjacent points is greater than the threshold.

In embodiments, the setting of a threshold for the variation includes: setting the threshold based on an angular resolution of the LiDAR.

In embodiments, the setting of the threshold based on an angular resolution of the LiDAR includes: setting the threshold to be greater than or equal to a product of the angular resolution of the LiDAR and a scanning distance. The scanning distance is a distance from the laser origin to a detection position.

In embodiments, the filtering out of non-ground points from the point cloud based on the key points includes: obtaining regions in the top view plane by dividing the top view plane in a radial direction based on the key points; acquiring height information of the respective regions based on the point cloud; and determining whether points within the respective regions are non-ground points based on the height information.

In embodiments, the filtering out of non-ground points from the point cloud based on the key points includes: acquiring, in the top view plane, a plurality of key points on a straight line connecting the coordinate origin with a key point; obtaining height information of a region between two adjacent key points on the straight line, based on the point cloud; and determining whether a point in the region is a non-ground point based on the height information.

In a second aspect, according to an embodiment, a device for filtering out non-ground points from a point cloud is provided, the device includes: a point cloud acquisition unit configured to acquire a point cloud by scanning the ground with light detection and ranging (LiDAR); a radial distance calculation unit configured to calculate radial distances of adjacent points in the point cloud; a key point determination unit configured to determine key points based on a variation of the radial distances of adjacent points; and a ground detection unit configured to filter out non-ground points from the point cloud based on the key points.

In embodiments, the adjacent points include points obtained by scanning the ground using adjacent laser heads of the LiDAR or points obtained by scanning the ground using one laser head of the LiDAR at adjacent scanning angles. The radial distance is a distance from a projection position of a point of the point cloud to a coordinate origin in the top view plane. The coordinate origin in the top view plane is a projection of a laser origin in the top view plane.

In embodiments, the key point determination unit includes: a setting subunit configured to set a threshold for the variation of the radial distances; and a determination subunit configured to determine at least one of the adjacent points as a key point, in a case that the variation of the radial distances of the adjacent points is greater than the threshold.

In embodiments, the setting subunit is further configured to set the threshold based on an angular resolution of the LiDAR.

In embodiments, the setting subunit is further configured to set the threshold to be greater than or equal to a product of the angular resolution of the LiDAR and a scanning distance. The scanning distance is a distance from the laser origin to a detection position.

In embodiments, the ground detection unit is further configured to: obtain regions in the top view plane by dividing the top view plane in a radial direction based on the key points; acquire height information of the respective regions based on the point cloud; and determine whether points within the respective regions are non-ground points based on the height information.

In embodiments, the ground detection unit is further configured to: acquire, in the top view plane, a plurality of key points on a straight line connecting the coordinate origin with a key point; obtain height information of a region between two adjacent key points on the straight line, based on the point cloud; and determine whether a point in the region is a non-ground point based on the height information.

In embodiments, a device for filtering out non-ground points from a point cloud includes a processor and a memory for storing a program which supports the device for filtering out non-ground points from a point cloud in executing the method for filtering out non-ground points from a point cloud described above in the first aspect, and the processor is configured to execute the program stored in the memory. The device for filtering out non-ground points from a point cloud can further include a communication interface for enabling the device for filtering out non-ground points from a point cloud to communicate with other devices or communication networks.

In a third aspect, a device for filtering out non-ground points from a point cloud is provided, according to an embodiment. The device includes: one or more processors; and a storage device configured to store one or more programs; wherein the one or more programs, when executed by the one or more processors, cause the one or more processors to implement any one of the above methods according to the first aspect.

In a fourth aspect, a computer readable storage medium is provided according to an embodiment. The computer readable storage medium is configured to store a computer program which, when executed by a processor, causes the processor to implement any one of the described methods.

The above technical solutions have the following advantages or advantageous effects. The key points are determined based on the radial distances of adjacent points in the point cloud, and then the non-ground points are filtered out. The calculation method is simple, the amount of calculation is small, and the execution speed is fast. Furthermore, the defect of inaccurate ground fitting in existing technologies is overcome. The determination result is more reliable. A small height variation can be detected sharply, thereby improving the accuracy of obstacle detection.

The above summary is for the purpose of the specification only and is not intended to be limiting in any way. In addition to the illustrative aspects, embodiments, and features described above, further aspects, embodiments, and features of the present disclosure will be readily understood by reference to the drawings and the following detailed description.

### BRIEF DESCRIPTION OF THE DRAWINGS

In the drawings, unless otherwise specified, identical or similar parts or elements are denoted by identical reference signs throughout several figures of the accompanying drawings. The drawings are not necessarily drawn to scale. It should be understood that these drawings merely illustrate some embodiments, and should not be construed as limiting the scope of the disclosure.

FIG. 1 is a flowchart of a method for filtering out non-ground points from a point cloud according to an embodiment.

FIG. 2 is a schematic diagram showing spatial coordinates of a laser origin and a radial distance in a method for filtering out non-ground points from a point cloud according to another embodiment.

FIG. 3a is a schematic diagram showing a variation of radial distances of adjacent upper and lower laser heads in a method for filtering out non-ground points from a point cloud according to another embodiment.

FIG. 3b is a schematic diagram showing a variation of radial distances of one laser head at adjacent left and right scanning angles in a method for filtering out non-ground points from a point cloud according to another embodiment.

FIG. 4 is a schematic diagram of obstacle detection in a method for filtering out non-ground points from a point cloud according to another embodiment.

FIG. 5 is a detection flowchart of a method for filtering out non-ground points from a point cloud according to another embodiment.

FIG. 6 is a detection flowchart of a method for filtering out non-ground points from a point cloud according to another embodiment.

FIG. 7 is a block diagram showing the structure of a device for filtering out non-ground points from a point cloud according to an embodiment.

FIG. 8 is a block diagram showing the structure of a device for filtering out non-ground points from a point cloud according to another embodiment.

FIG. 9 is a block diagram showing the structure of a device for filtering out non-ground points from a point cloud according to another embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

In the following, only certain example embodiments are briefly described. As those skilled in the art would realize, the described embodiments may be modified in various different ways, all without departing from the spirit or scope of the present disclosure. Accordingly, the drawings and description are to be regarded as illustrative in nature and not restrictive.

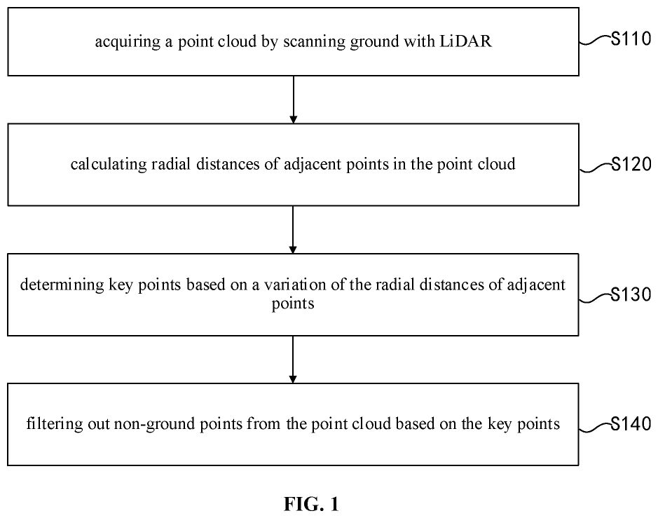

FIG. 1 is a flowchart of a method for filtering out non-ground points from a point cloud according to an embodiment. As shown in FIG. 1, the method for filtering out the non-ground points from a point cloud according to the embodiment includes at S110, acquiring a point cloud by scanning the ground with LiDAR. At S120, the method includes calculating radial distances of adjacent points in the point cloud. At S130, the method includes determining key points based on a variation of the radial distances of adjacent points. At S140, the method includes filtering out non-ground points from the point cloud based on the key points.

Data measured by Light Detection and Ranging (LiDAR) include a discrete point representation of a Digital Surface Model (DSM). The data contain spatial three-dimensional information, laser intensity information, and so on. A laser beam is emitted from a sensor, travels to the ground or an object surface via air, and then is reflected by the ground or the surface of the object. The reflected energy is received by a sensor and recorded as an electrical signal. If an emission time instant and an reception time instant are accurately recorded, a distance (R) from the laser to the ground or the surface of the object can be calculated using the following formula: R=ct/2, where c represents the speed of light, and t represents a time difference between the emission time instant and the reception time instant. A light pulse travels at the speed of light. A beam of discrete light pulses is emitted from a laser emitter, arrives at the earth's surface and is reflected. A receiver always receives a light pulse reflected back before a next light pulse is emitted. The distance is obtained by recording a time period during which the instantaneous laser travels to the target.

In an embodiment, by using ordered information on the LiDAR points, some key points are found by determining a variation of the radial distances of adjacent points, and all the non-ground points are filtered out based on these key points.

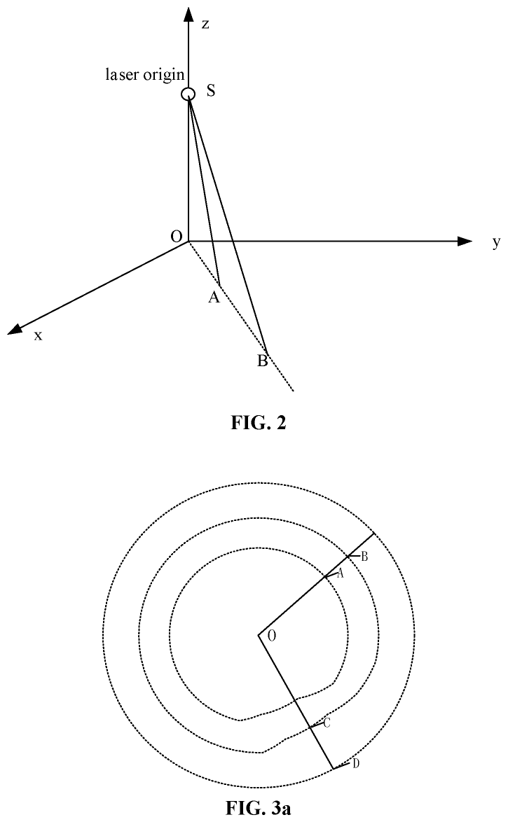

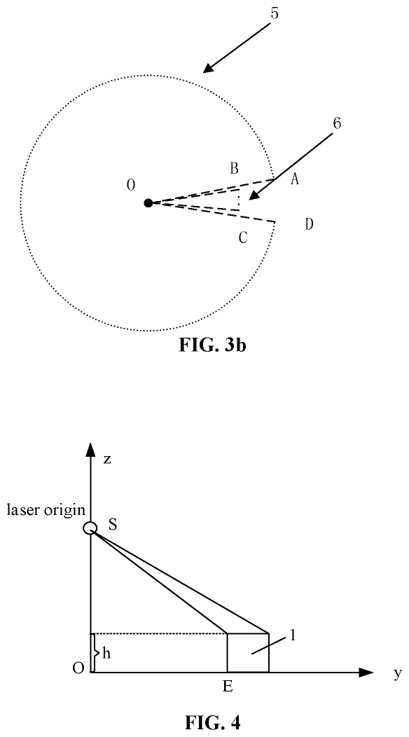

FIG. 2 is a schematic diagram showing spatial coordinates of a laser origin and a radial distance in a method for filtering out non-ground points from a point cloud according to another embodiment. FIG. 3a is a schematic diagram showing a variation of radial distances of adjacent upper and lower laser heads in a method for filtering out non-ground points from a point cloud according to another embodiment. For ease of explanation, reference is made to both FIG. 2 and FIG. 3a. The adjacent points include points obtained by scanning the ground using adjacent laser heads of the LiDAR or points obtained by scanning the ground using one laser head of the LiDAR at adjacent scanning angles. The radial distance is a distance from a projection position of a point of the point cloud to a coordinate origin in the top view plane. The coordinate origin of the top view plane (such as plane xy in FIG. 2) is a projection of a laser origin S in the top view plane.

In an embodiment, multiple laser heads can be generally configured for a LiDAR device, such as 64 laser heads. The laser head can have a horizontal scanning direction. For any laser head, by taking the horizontal scanning as an example, if the ground is flat, a point cloud generated can be a complete circle (see the largest circle in FIG. 3a). In FIG. 2, multiple laser heads emit laser signals. In this case, a location model for the laser heads can be equivalent to that all the laser heads are located at the laser origin S in FIG. 2, with emission angles of the laser heads each being different. Referring to FIG. 3a, if the ground is flat, a gradient of variation of the radial distances is very uniform. However, if there is an obstacle (such as a person, a vehicle, a tree, and the like), the distance can suddenly be enlarged at the edge of the obstacle. For example, in FIG. 3a, the gradient of variation of the radial distances at points A and B is very uniform; circle curves are distorted respectively at point C and point D; the gradient of variation of the radial distances at points C and D is non-uniform, and the distance between point C and point D is enlarged.

The radial distances of adjacent points in the point cloud can be represented as distances from projections of the adjacent points in the top view plane (plane xy) to the coordinate origin of the top view plane. Referring to FIG. 2, a distance from point A or point B to the coordinate origin O in plane xy is a radial distance. That is, OA and OB in FIG. 2 are radial distances. Assuming that the length of OA is L1 and the length of OB is L2, then a variation of the radial distances is P=L2−L1.

Using the ordered information on LiDAR points, the radial distances OA and OB of the adjacent points can be calculated. Further, a variation P of the radial distances of the adjacent points, that is, the length of a line segment AB, can be calculated. Key points can be determined based on the variation of the radial distances.

FIG. 3b is a schematic diagram showing a variation of radial distances by one laser head at adjacent left and right scanning angles in a method for filtering out non-ground points from a point cloud according to another embodiment. Reference numeral 5 in FIG. 3b represents the i-th scanning line of the LiDAR. Reference numeral 6 in FIG. 3b represents an obstacle such as a person or a vehicle. In FIG. 3b, a projection of a certain scanning lines of the LiDAR on the ground are depicted, i.e., scanning points of one laser head at different angles indicated by reference numeral 5 in FIG. 3b. A position BC shown by reference numeral 6 is the position of obstacle (such as a person or a vehicle). Affected by the obstacle, a radial distance of point B is less than a radial distance of point A adjacent to point B, and a radial distance of point C is less than a radial distance of point D adjacent to point C, i.e., OA>OB and OD>OC. In addition, the obstacle is higher than the ground, hence the average height of the segment BC is greater than the heights of point A and point D. Further, a variation of the radial distances of adjacent points, that is, the length of line segment AB and the length of line segment CD, can be calculated. The key points can be determined based on the variation of the radial distances.

In one embodiment, determining key points based on a variation of the radial distances of adjacent points includes: setting a threshold for the variation of the radial distances; and determining at least one of the adjacent points as a key point, if the variation of the radial distances of the adjacent points is greater than the threshold. The key point can represent a boundary point of different regions where two adjacent objects are respectively located. It can be seen from the point cloud information that the key point is a point at which the radial distance varies abnormally and non-uniformly. In an embodiment, if the variation of the radial distances of the adjacent points is greater than the threshold, one of the adjacent points which has a smaller radial distance is determined as the key point.

In an embodiment, the setting a threshold for the variation includes: setting the threshold based on an angular resolution of the LiDAR. Further, the key points are determined based on the threshold.

In an embodiment, the setting the threshold based on an angular resolution of the LiDAR includes: setting the threshold to be greater than or equal to a product of the angular resolution of the LiDAR and a scanning distance. The scanning distance is a distance from the laser origin to a detection position.

The angular resolution is represented as AO. Referring to FIG. 2, AO is an included angle between SA and SB. The threshold can be set as follows.

In a sector having a central angle of Δθ and a radius of R, the arc length of an arc corresponding to the central angle is: L=Δθ*R.

In theory, the variation of the radial distances of adjacent points is less than the arc length L. Thus, in a possible embodiment, the threshold can be set as Δθ*R. If the variation of the radial distances of adjacent points is greater than the threshold, it is determined that the position is a region in which a key point is located.

FIG. 5 is a detection flowchart of a method for filtering out non-ground points from a point cloud according to another embodiment. As shown in FIG. 5, in an embodiment, S140 in FIG. 1 of filtering out non-ground points from the point cloud based on the key points is further depicted. In particular, at S210, the method can include obtaining regions in the top view plane by dividing the top view plane in a radial direction based on the key points. At S220, the method can include acquiring height information of the respective regions based on the point cloud. At S230, the method can include determining whether points within the respective regions are non-ground points based on the height information.

Regions located at two sides of the key point are respectively related to two objects. The region located at a certain side can be related to the ground, or neither of the regions located at the two sides is related to the ground. Generally, continuous point cloud information can be generated when a laser head scans on the ground and scans on the surface of the obstacle. If the gradient of variation of the radial distance of a point is large, two sides of this point should be related to two objects, and the point is determined as a key point. Based on this determination, if other features are considered, for example, adding some thresholds for height for the determination, it is easy to know which side of the key point is related to the ground.

The determining whether points within the respective regions are non-ground points based on the height information can include the following two embodiments.

In a first embodiment, a height difference between the regions at the two sides of the key point can be determined based on the point cloud. In a case where the height difference is large, for example, in a case where the height difference is larger than a preset height difference threshold, the higher one of the regions at the two sides of the key point is determined as a region in which the obstacle is located, that is, non-ground points. FIG. 4 is a schematic diagram of obstacle detection in a method for filtering out non-ground points from a point cloud according to another embodiment. As shown in FIG. 4, a rectangle assigned with the number 1 indicates an obstacle, point E is a key point in the top view plane, and regions located at two sides of point E are respectively related to two objects. A height difference h between the regions at the two sides of the key point can be determined based on the point cloud. In addition, a height difference threshold can be set based on the size of the obstacle. For example, the height of a car is generally between 1400 mm and 1600 mm, and the height of an adult is generally between 1500 mm and 1900 mm. If the height difference between the regions at the two sides of point E is greater than the preset height difference threshold, the region at the right side of point E, that is, the region at the higher side is determined as the region in which the obstacle is located.

In a second embodiment, the heights of regions at two sides of a key point can be compared based on the point cloud, and the higher one of the regions at the two sides of the key point is determined as a region in which an obstacle is located, that is, non-ground points. Further, for the lower region of the regions at the two sides of the key point, searching can be performed in the scanning region to find whether there is a region having a height value less than that of the lower region. If there is a region having a height value less than that of the lower region, the lower region is determined as the region in which the obstacle is located, that is, non-ground points.

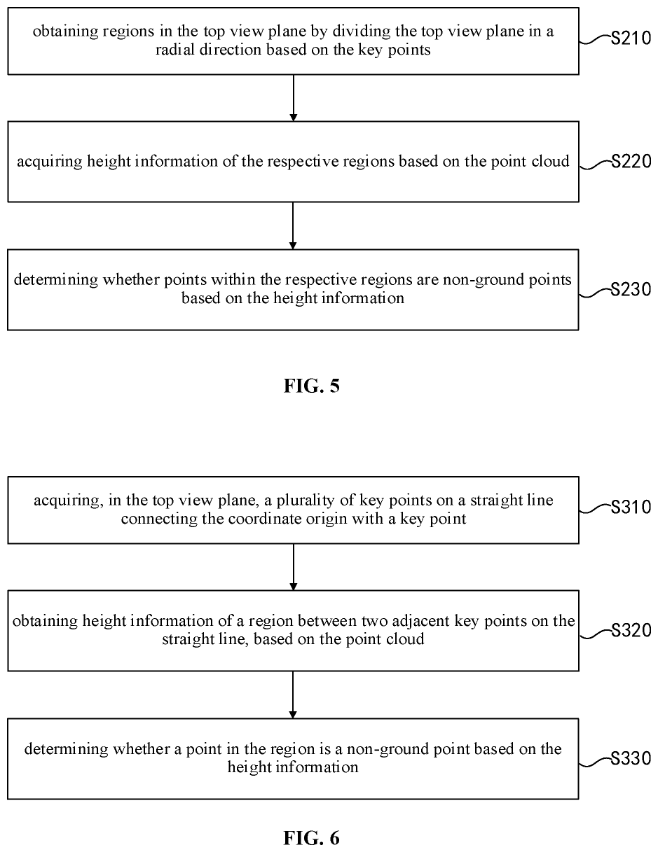

FIG. 6 is a detection flowchart of a method for filtering out non-ground points from a point cloud according to another embodiment. As shown in FIG. 6, in an embodiment, S140 in FIG. 1 of filtering out non-ground points from the point cloud based on the key points is further depicted. For example, the method can include at S310, acquiring, in the top view plane, a plurality of key points on a straight line connecting the coordinate origin with a key point. At S320, the method can include obtaining height information of a region between two adjacent key points on the straight line based on the point cloud. At S330, the method can include determining whether a point in the region is a non-ground point based on the height information.

For example, in point cloud information on a straight line, two segmentation points can be sequentially obtained in a direction away from the coordinate origin. These two segmentation points are at two edges of the obstacle. It can be further determined that a region between the segmentation points is related to the obstacle.

Furthermore, it can be determined based on the height information whether points in the respective regions are non-ground points, according to the above two embodiments, and a detailed description is omitted herein.

The above technical solutions have the following advantages or advantageous effects. The key points are determined based on the radial distances of adjacent points in the point cloud, and then the non-ground points are filtered out. The calculation method is simple, the amount of calculation is small, and the execution speed is fast. Furthermore, the defect of inaccurate ground plane fitting in conventional technologies is overcome. The determination result is more reliable. A small height variation can be detected sharply, thereby improving the accuracy of obstacle detection.

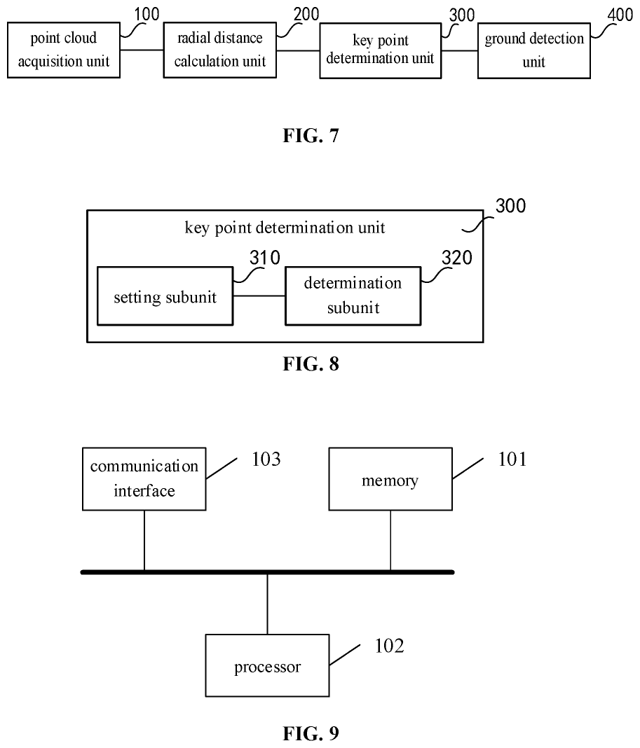

FIG. 7 is a block diagram showing the structure of a device for filtering out non-ground points from a point cloud according to an embodiment. As shown in FIG. 7, the device for filtering out non-ground points from a point cloud according to the embodiment includes: a point cloud acquisition unit 100 configured to acquire a point cloud by scanning the ground with LiDAR; a radial distance calculation unit 200 configured to calculate radial distances of adjacent points in the point cloud; a key point determination unit 300 configured to determine key points based on a variation of the radial distances of adjacent points; and a ground detection unit 400 configured to filter out non-ground points from the point cloud based on the key points.

In an embodiment, the adjacent points include points obtained by scanning the ground using adjacent laser heads of the LiDAR or points obtained by scanning the ground using one laser head of the LiDAR at adjacent scanning angles. The radial distance is a distance from a projection position of a point of the point cloud to a coordinate origin in the top view plane. The coordinate origin in the top view plane is a projection of a laser origin in the top view plane.

FIG. 8 is a block diagram showing the structure of a device for filtering out non-ground points from a point cloud according to another embodiment. As shown in FIG. 8, in a possible embodiment, the key point determination unit 300 includes: a setting subunit 310 configured to set a threshold for the variation of the radial distances; and a determination subunit 320 configured to determine at least one of the adjacent points as a key point, if the variation of the radial distances of the adjacent points is greater than the threshold.

In an embodiment, the setting subunit 310 is further configured to set the threshold based on an angular resolution of the LiDAR.

In another embodiment, the setting subunit 310 is further configured to set the threshold to be greater than or equal to a product of the angular resolution of the LiDAR and a scanning distance. The scanning distance is a distance from the laser origin to a detection position.

In an embodiment, the ground detection unit 400 is further configured to: obtain regions in the top view plane by dividing the top view plane in a radial direction based on the key points; acquire height information of the respective regions based on the point cloud; and determine whether points within the respective regions are non-ground points based on the height information.

In an embodiment, the ground detection unit 400 is further configured to: acquire, in the top view plane, a plurality of key points on a straight line connecting the coordinate origin with a key point; obtain height information of a region between two adjacent key points on the straight line, based on the point cloud; and determine whether a point in the region is a non-ground point based on the height information.

One skilled in the art will appreciate that the functions of various units in the device for filtering out non-ground points from a point cloud can mirror those described with respect to the methods, as a repeated description is not provided herein for ease of explanation.

In an embodiment, a device for filtering out non-ground points from a point cloud includes a processor and a memory for storing a program which supports the device for filtering out non-ground points from a point cloud in executing the method for filtering out non-ground points from a point cloud described above, and the processor is configured to execute the program stored in the memory. The device for filtering out non-ground points from a point cloud can further include a communication interface for enabling the device for filtering out non-ground points from a point cloud to communicate with other devices or communication networks.

FIG. 9 is a block diagram showing the structure of a device for filtering out non-ground points from a point cloud according to another embodiment. As shown in FIG. 9, the device includes a memory 101 and a processor 102, wherein a computer program that can run on the processor 102 is stored in the memory 101; when the processor 102 executes the computer program, the method for filtering out non-ground points from a point cloud according to the above embodiment is implemented; the number of the memory 101 and the processor 102 can each be one or more.

The device further can further include a communication interface 103 configured to communicate with an external device to realize data interaction and transmission.

The memory 101 can include a high-speed RAM memory, or can also include a non-volatile memory, such as at least one disk memory. If the memory 101, the processor 102 and the communication interface 103 are implemented independently, the memory 101, the processor 102 and the communication interface 103 can be connected to each other via a bus so as to realize mutual communication. The bus can be an industry standard architecture (ISA) bus, a peripheral component interconnect (PCI) bus, an extended industry standard architecture (EISA) bus, or the like. The bus can be categorized into an address bus, a data bus, a control bus or the like. For ease of illustration, only one bold line is shown in FIG. 9 to represent the bus, but it does not mean that there is only one bus or only one type of bus.

Optionally, in a specific embodiment, if the memory 101, the processor 102 and the communication interface 103 are integrated on one chip, then the memory 101, the processor 102 and the communication interface 103 can complete mutual communication through an internal interface.

According to an embodiment of the present disclosure, a computer-readable storage medium is provided for storing computer software instructions, which include programs involved in execution of the above the method.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present disclosure. Furthermore, the specific features, structures, materials, or characteristics described can be combined in any suitable manner in any one or more of the embodiments or examples. In addition, different embodiments or examples described in this specification and features of different embodiments or examples can be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” can explicitly or implicitly include at least one of the features. In the description of the present disclosure, “a plurality of” means two or more, unless expressly limited otherwise.

Any process or method descriptions described in flowcharts or otherwise herein can be understood as representing modules, segments or portions of code that include one or more executable instructions for implementing the steps of a particular logic function or process. The scope of the preferred embodiments of the present disclosure includes additional embodiments where the functions are not performed in the order shown or discussed, including according to the functions involved, in substantially simultaneous or in reverse order, which should be understood by those skilled in the art to which the embodiment of the present disclosure belongs.

Logic and/or steps, which are represented in the flowcharts or otherwise described herein, for example, can be thought of as a sequencing listing of executable instructions for implementing logic functions, which can be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” can be any device that can contain, store, communicate, propagate, or transport the program for use by or in connection with the instruction execution system, device, or apparatus. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium can even be paper or other suitable medium upon which the program can be printed, as it can be read, for example, by optical scanning of the paper or other medium, followed by editing, interpretation or, where appropriate, process otherwise to electronically obtain the program, which is then stored in a computer memory.

It should be understood that various portions of the present disclosure can be implemented by hardware, software, firmware, or a combination thereof. In the above embodiments, multiple steps or methods can be implemented in software or firmware stored in memory and executed by a suitable instruction execution system. For example, if implemented in hardware, as in another embodiment, they can be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art can understand that all or some of the steps carried in the methods in the foregoing embodiments can be implemented by a program instructing relevant hardware. The program can be stored in a computer-readable storage medium, and when executed, one of the steps of the method embodiment or a combination thereof is included.

In addition, each of the functional units in the embodiments of the present disclosure can be integrated in one processing module, or each of the units can exist alone physically, or two or more units can be integrated in one module. The above-mentioned integrated module can be implemented in the form of hardware or in the form of software functional module. When the integrated module is implemented in the form of a software functional module and is sold or used as an independent product, the integrated module can also be stored in a computer-readable storage medium. The storage medium can be a read only memory, a magnetic disk, an optical disk, or the like.

The foregoing descriptions are merely specific embodiments of the present disclosure, but not intended to limit the protection scope of the present disclosure. Those skilled in the art can easily conceive of various changes or modifications within the technical scope disclosed herein, all these should be covered within the protection scope of the present disclosure. Therefore, the protection scope of the present disclosure should be subject to the protection scope of the claims.

Various embodiments of systems, devices, and methods have been described herein. These embodiments are given only by way of example and are not intended to limit the scope of the claimed inventions. It should be appreciated, moreover, that the various features of the embodiments that have been described can be combined in various ways to produce numerous additional embodiments. Moreover, while various materials, dimensions, shapes, configurations and locations, etc. have been described for use with disclosed embodiments, others besides those disclosed can be utilized without exceeding the scope of the claimed inventions.

Persons of ordinary skill in the relevant arts will recognize that the subject matter hereof can comprise fewer features than illustrated in any individual embodiment described above. The embodiments described herein are not meant to be an exhaustive presentation of the ways in which the various features of the subject matter hereof can be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim can refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A method for filtering out non-ground points from a point cloud, comprising:
acquiring a point cloud by scanning ground with light detection and ranging (LiDAR);
calculating radial distances of adjacent points in the point cloud;
determining key points based on a variation of the radial distances of adjacent points; and
filtering out non-ground points from the point cloud based on the key points.

2. The method of claim 1, wherein the adjacent points comprise points obtained by scanning the ground using adjacent laser heads of the LiDAR or points obtained by scanning the ground using one laser head of the LiDAR at adjacent scanning angles, and wherein the radial distance is a distance from a projection position of a point of the point cloud to a coordinate origin in the top view plane, and the coordinate origin in the top view plane is a projection of a laser origin in the top view plane.

3. The method of claim 1, wherein the determining key points based on a variation of the radial distances of adjacent points comprises:
setting a threshold for the variation of the radial distances; and
determining at least one of the adjacent points as a key point, wherein the variation of the radial distances of adjacent points is greater than the threshold.

4. The method of claim 3, wherein the setting a threshold for the variation comprises setting the threshold based on an angular resolution of the LiDAR.

5. The method of claim 4, wherein the setting the threshold based on an angular resolution of the LiDAR comprises:
setting the threshold to be greater than or equal to a product of the angular resolution of the LiDAR and a scanning distance,
wherein the scanning distance is a distance from the laser origin to a detection position.

6. The method of claim 1, wherein the filtering out non-ground points from the point cloud based on the key points comprises:
obtaining regions in the top view plane by dividing the top view plane in a radial direction based on the key points;
acquiring height information of the respective regions based on the point cloud; and
determining whether points within the respective regions are non-ground points based on the height information.

7. The method of claim 2, wherein the filtering out non-ground points from the point cloud based on the key points comprises:
acquiring, in the top view plane, a plurality of key points on a straight line connecting the coordinate origin with a key point;
obtaining height information of a region between two adjacent key points on the straight line, based on the point cloud; and
determining whether a point in the region is a non-ground point based on the height information.

8. A device for filtering out non-ground points from a point cloud, comprising:
one or more processors; and
a storage device configured to store one or more programs, that, when executed by the one or more processors, cause the one or more processors to:
acquire a point cloud by scanning the ground with light detection and ranging (LiDAR),
calculate radial distances of adjacent points in the point cloud,
determine key points based on a variation of the radial distances of adjacent points, and
filter out non-ground points from the point cloud based on the key points.

9. The device of claim 8, wherein the adjacent points comprise points obtained by scanning the ground using adjacent laser heads of the LiDAR or points obtained by scanning the ground using one laser head of the LiDAR at adjacent scanning angles, wherein the radial distance is a distance from a projection position of a point of the point cloud to a coordinate origin in the top view plane, and the coordinate origin in the top view plane is a projection of a laser origin in the top view plane.

10. The device of claim 8, wherein the one or more programs, when executed by the one or more processors, cause the one or more processors further to:
set a threshold for the variation of the radial distances; and
determine at least one of the adjacent points as a key point, wherein the variation of the radial distances of the adjacent points is greater than the threshold.

11. The device of claim 10, wherein the one or more programs, when executed by the one or more processors, cause the one or more processors further to set the threshold based on an angular resolution of the LiDAR.

12. The device of claim 11, wherein the one or more programs, when executed by the one or more processors, cause the one or more processors further to:
set the threshold to be greater than or equal to a product of the angular resolution of the LiDAR and a scanning distance,
wherein the scanning distance is a distance from the laser origin to a detection position.

13. The device of claim 8, wherein the one or more programs, when executed by the one or more processors, cause the one or more processors further to:
obtain regions in the top view plane by dividing the top view plane in a radial direction based on the key points;
acquire height information of the respective regions based on the point cloud; and
determine whether points within the respective regions are non-ground points based on the height information.

14. The device of claim 9, wherein the one or more programs, when executed by the one or more processors, cause the one or more processors further to:
acquire, in the top view plane, a plurality of key points on a straight line connecting the coordinate origin with a key point;
obtain height information of a region between two adjacent key points on the straight line based on the point cloud; and
determine whether a point in the region is a non-ground point based on the height information.

15. A non-transitory computer readable storage medium, in which a computer program is stored, wherein the program, when executed by a processor, causes the processor to execute a method for filtering out non-ground points from a point cloud, comprising:
acquiring a point cloud by scanning ground with light detection and ranging (LiDAR);
calculating radial distances of adjacent points in the point cloud;
determining key points based on a variation of the radial distances of adjacent points; and
filtering out non-ground points from the point cloud based on the key points.
